(19) United States
(12) Patent Application Publication
(10) Pub. No.: US 2007/0246691 A1
(43) Pub. Date: Oct. 25, 2007

(54) Electrolyte for anodizing magnesium products

(75) Inventors: Zhong-Wu Luo, Shenzhen (CN); Jun Lin, Shenzhen (CN); Lin Jian, Shenzhen (CN); Tie-Qiang Peng, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Hon Hai Precision Industry Co., LTD.

(21) Appl. No.: 11/701,806

(22) Filed: Feb. 2, 2007

(30) Foreign Application Priority Data
Apr. 19, 2006 (CN) 200610060396.4

(51) Int. Cl. H01B 1/12

(52) U.S. Cl. 252/519.3; 252/500; 252/521.2; 252/521.5

(57) ABSTRACT

An electrolyte for anodizing magnesium products, includes a base solution, a main blackening agent, an auxiliary blackening agent, and a complexing agent. The base solution includes 2 to 25 g/l of alkali, 1 to 30 g/l of fluoride, and 1 to 35 g/l of silicate. The main blackening agent mainly includes cupric salt, concentration of the cupric salt is from 0.3 to 9 grams per liter (g/l). The auxiliary blackening agent mainly includes oxysalt, concentration of the oxysalt is from 0.1 to 8 g/l. Concentration of the complexing agent is from 0.5 to 20 g/l.

### CROSS-REFERENCES TO RELATED APPLICATION

Relevant subject matter is disclosed in the co-pending U.S. patent application (Attorney Docket No. US10093) filed on the same date and entitled “METHOD FOR ANODIZING MAGNESIUM PRODUCTS”, which is assigned to the same assignee with this patent application.

### BACKGROUND OF THE INVENTION

1. Field of the Invention

The present invention relates to an electrolyte for anodizing magnesium products.

2. Description of related art

Magnesium is widely used in industry because of its low specific gravity, excellent electro magnetic interference (EMI) shielding capability, and adaptability to volume production. Typically, magnesium products require surface treatment, to protect and enhance wearability and inoxidability of their surfaces.

To address aforementioned requirement, the practice of coating magnesium materials with a thin layer is used. China Patent No. 86108405 discloses a method, and an electrolyte for anodizing magnesium products. The electrolyte includes alkali silicate (such as potassium metasilicate), alkali hydroxide (such as potassium hydroxide), and fluoride (such as potassium fluoride). A magnesium material and an auxiliary cathode are put in the electrolyte, and power is supplied between the magnesium material and the auxiliary cathode. Ceramic coating consisting of magnesia is formed on the surface of the magnesium material by spark discharge between the magnesium material and the auxiliary cathode. However, the ceramic coating on the magnesium material is white, it needs to be painted when the magnesium material is used in a dark colored product for aesthetic reasons.

What is needed, therefore, is an electrolyte for anodizing magnesium products with a black coating.

### SUMMARY OF THE INVENTION

An exemplary electrolyte is provided for anodizing magnesium products. The electrolyte includes a base solution, a main blackening agent, an auxiliary blackening agent, and a complexing agent. The main blackening agent mainly includes cupric salt, concentration of the cupric salt is from 0.3 to 9 grams per liter (g/l). The auxiliary blackening agent mainly includes oxysalt, concentration of the oxysalt is from 0.1 to 8 g/l. Concentration of the complexing agent is from 0.5 to 20 g/l.

Other advantages and novel features will become more apparent from the following detailed description of preferred embodiments, in which:

### DETAILED DESCRIPTION OF THE INVENTION

An electrolyte used for anodizing magnesium products in accordance with a preferred embodiment of the present invention is provided. A magnesium alloy substrate material as an anode is put in the electrolyte, and another metal (such as stainless steel, or other infusible inert metal) as a cathode is put in the electrolyte. Supplying power between the anode and the cathode until a black coating is formed on the magnesium alloy substrate material by the means of spark discharge. The electrolyte includes a base solution, a main blackening agent, an auxiliary blackening agent, a complexing agent, and an inhibitor. Temperature of the electrolyte is preferably kept between 10 to 60 degrees Celsius (° C.).

The base solution includes alkali, fluoride, silicate, and water. Concentration of the alkali is from 2 to 25 grams per liter (g/l), and preferably from 8 to 12 g/l. Concentration of the fluoride is from 1 to 30 g/l, and preferably from 8 to 12 g/l. Concentration of the silicate is from 1 to 35 g/l, and preferably from 3 to 8 g/l. The alkali includes at least one item selected from the group consisting of potassium hydroxide, and sodium hydroxide. The fluoride includes at least one item selected from the group consisting of potassium fluoride, sodium fluoride, ammonium fluoride, and other compounds including fluorinion. The silicate includes at least one item selected from the group consisting of potassium metasilicate, sodium silicate, potassium fluosilicate, and sodium fluosilicate.

The main blackening agent mainly includes cupric salt. The cupric salt includes at least one item selected from the group consisting of cupric hydroxide, basic copper carbonate, cupric pyrophosphate, cupric citrate, and other metal salts including cupric ions. Concentration of the cupric salt is from 0.3 to 9 g/l, and preferably from 1 to 3 g/l.

The auxiliary blackening agent includes at least one item selected from the group consisting of nickel nitrate, ammonium molybdate, ammonium metavanadate, and other oxysalts. Concentration of the auxiliary blackening agent is from 0.1 to 8 g/l, and preferably from 2 to 4 g/l.

The complexing agent includes at least one item selected from the group consisting of acid and salt of ammonia, ethylenediamine tetracetic acid (EDTA), citric acid, tartaric acid, ethylenediamine, and trolamine. Concentration of the complexing agent is from 0.5 to 20 g/l, and preferably from 3 to 5 g/l.

The inhibitor included in the electrolyte works to increase blackening, and prevent corrosion of the magnesium product. The inhibitor includes at least one item selected from the group consisting of thiourea, sodium m-nitrobenzene sulfonate, and methenamine. Each of the group consisting of thiourea, sodium m-nitrobenzene sulfonate, and methenamine includes amido, hydroxyl, nitryl, or other adsorbing radicals. Concentration of the inhibitor is from 0 to 5 g/l, and preferably from 0.5 to 2 g/l.

The present invention may be explained by means of the following embodiment examples:

### EXAMPLE 1

Composition of the electrolyte:

| | |
|---|---|
| sodium hydroxide | 25 g/l |
| sodium silicate | 1 g/l |
| potassium fluoride | 10 g/l |
| cupric pyrophosphate | 4 g/l |
| nickel nitrate | 0.1 g/l |
| sodium citrate | 8 g/l |
| thiourea | 1 g/l |

Temperature of the electrolyte is held at 35° C.;
Color of the coating formed on the magnesium product: black;
Thickness of the coating formed on the magnesium product: 10 micrometers (μm).

### EXAMPLE 2

Composition of the electrolyte:

| | |
|---|---|
| sodium hydroxide | 13 g/l |
| sodium silicate | 8 g/l |
| potassium fluoride | 13 g/l |
| cupric pyrophosphate | 1.8 g/l |
| nickel nitrate | 0.1 g/l |
| sodium citrate | 5 g/l |
| thiourea | 0.1 g/l |

Temperature of the electrolyte is held at 25° C.;
Color of the coating formed on the magnesium product: black;
Thickness of the coating formed on the magnesium product: 14 μm.

### EXAMPLE 3

Composition of the electrolyte:

| | |
|---|---|
| potassium hydroxide | 2 g/l |
| sodium silicate | 35 g/l |
| potassium fluoride | 1 g/l |
| cupric pyrophosphate | 6 g/l |
| nickel nitrate | 0.1 g/l |
| disodium ethylenediamine tetraacetate | 3 g/l |
| methenamine | 0.1 g/l |

Temperature of the electrolyte is held at 60° C.;
Color of the coating formed on the magnesium product: reddish black;
Thickness of the coating formed on the magnesium product: 14 μm.

### EXAMPLE 4

Composition of the electrolyte:

| | |
|---|---|
| sodium hydroxide | 15 g/l |
| sodium silicate | 21 g/l |
| potassium fluoride | 10 g/l |
| cupric hydroxide | 0.3 g/l |
| ammonium molybdate | 1 g/l |
| ethylenediamine | 0.5 g/l |
| thiourea | 1 g/l |

Temperature of the electrolyte is held at 35° C.;
Color of the coating formed on the magnesium product: black;
Thickness of the coating formed on the magnesium product: 8 μm.

### EXAMPLE 5

Composition of the electrolyte:

| | |
|---|---|
| sodium hydroxide | 3 g/l |
| sodium silicate | 4 g/l |
| potassium fluoride | 30 g/l |
| cupric hydroxide | 4.5 g/l |
| ammonium molybdate | 0.6 g/l |
| ethylenediamine | 0.5 g/l |
| sodium citrate | 8 g/l |
| thiourea | 1.5 g/l |

Temperature of the electrolyte is held at 35° C.;
Color of the coating formed on the magnesium product: black;
Thickness of the coating formed on the magnesium product: 12 μm.

### EXAMPLE 6

Composition of the electrolyte:

| | |
|---|---|
| potassium hydroxide | 15 g/l |
| sodium silicate | 21 g/l |
| potassium fluoride | 10 g/l |
| cupric hydroxide | 1 g/l |
| cupric pyrophosphate | 8 g/l |
| ammonium metavanadate | 4 g/l |
| ethylenediamine | 5 g/l |
| sodium citrate | 15 g/l |
| thiourea | 1 g/l |

Temperature of the electrolyte is held at 35° C.;
Color of the coating formed on the magnesium product: bluish black;
Thickness of the coating formed on the magnesium product: 18 μm.

### EXAMPLE 7

Composition of the electrolyte:

| | |
|---|---|
| potassium hydroxide | 15 g/l |
| sodium silicate | 3 g/l |
| potassium fluoride | 15 g/l |
| cupric pyrophosphate | 1 g/l |
| ammonium metavanadate | 8 g/l |
| ethylenediamine | 2 g/l |
| potassium sodium tartrate | 12 g/l |

Temperature of the electrolyte is held at 35° C.;
Color of the coating formed on the magnesium product: black;
Thickness of the coating formed on the magnesium product: 11 μm.

### EXAMPLE 8

Composition of the electrolyte:

| | |
|---|---|
| potassium hydroxide | 25 g/l |
| sodium silicate | 11 g/l |
| potassium fluoride | 10 g/l |
| cupric hydroxide | 1 g/l |
| cupric pyrophosphate | 2 g/l |
| ammonium metavanadate | 2 g/l |
| ethylenediamine | 1 g/l |
| sodium citrate | 8 g/l |
| thiourea | 1 g/l |
| Methenamine | 4 g/l |

Temperature of the electrolyte is held at 10° C.;
Color of the coating formed on the magnesium product: black;
Thickness of the coating formed on the magnesium product: 5 μm.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electrolyte for anodizing magnesium products, the electrolyte comprising:
a base solution;
a main blackening agent mainly comprising cupric salt, concentration of the cupric salt ranging from 0.3 to 9 grams per liter (g/l);
an auxiliary blackening agent mainly comprising oxysalt, concentration of the oxysalt ranging from 0.1 to 8 grams per liter (g/l); and
a complexing agent, concentration of the complexing agent ranging from 0.5 to 20 g/l.

2. The electrolyte as claimed in claim 1, wherein the base solution comprises 2 to 25 g/l of alkali, 1 to 30 g/l of fluoride, and 1 to 35 g/l of silicate.

3. The electrolyte as claimed in claim 2, wherein concentration of the alkali is from 8 to 12 g/l, the fluoride from 8 to 12 g/l, and the silicate from 3 to 8 g/l.

4. The electrolyte as claimed in claim 2, wherein the alkali comprises at least one item selected from the group consisting of potassium hydroxide, and sodium hydroxide.

5. The electrolyte as claimed in claim 2, wherein the fluoride comprises at least one item selected from the group consisting of potassium fluoride, sodium fluoride, and ammonium fluoride.

6. The electrolyte as claimed in claim 2, wherein the silicate comprises at least one item selected from the group consisting of potassium metasilicate, sodium silicate, potassium fluosilicate, and sodium fluosilicate.

7. The electrolyte as claimed in claim 1, wherein the cupric salt comprises at least one item selected from the group consisting of cupric hydroxide, basic copper carbonate, cupric pyrophosphate, and cupric citrate.

8. The electrolyte as claimed in claim 1, wherein the oxysalt comprises at least one item selected from the group consisting of nickel nitrate, ammonium molybdate, and ammonium metavanadate.

9. The electrolyte as claimed in claim 1, wherein the complexing agent comprises at least one item selected from the group consisting of acid and salt of ammonia, ethylenediamine tetracetic acid (EDTA), citric acid, tartaric acid, ethylenediamine, and trolamine.

10. The electrolyte as claimed in claim 1, further comprising an inhibitor for increase of blackening and preventing corrosion of the magnesium products, wherein the inhibitor comprises at least one item selected from the group consisting of thiourea, sodium m-nitrobenzene sulfonate, and methenamine, each of the thiourea, sodium m-nitrobenzene sulfonate, and methenamine including amido, hydroxyl, or nitryl absorbing radicals, concentration of the inhibitor is from 0 to 5 g/l.

11. The electrolyte as claimed in claim 10, wherein concentration of the inhibitor is from 0.5 to 2 g/l.

12. The electrolyte as claimed in claim 1, wherein concentration of the cupric salt is from 1 to 3 g/l, the oxysalt from 2 to 4 g/l, and the complexing agent from 3 to 5 g/l.

13. An electrolyte for anodizing a magnesium product, the electrolyte comprising:
a base solution comprising 8 to 12 g/l of alkali, 8 to 12 g/l of fluoride, and 3 to 8 g/l of silicate;
a main blackening agent mainly comprising 1 to 3 g/l of cupric salt;
an auxiliary blackening agent mainly comprising 2 to 4 g/l of oxysalt; and
a complexing agent, concentration of the complexing agent ranging from 3 to 5 g/l.

14. The electrolyte as claimed in claim 13, further comprising an inhibitor, wherein the alkali is sodium hydroxide concentration of which is 13 grams per liter (g/l), the fluoride is potassium fluoride concentration of which is 13 g/l, the silicate is sodium silicate concentration of which is 8 g/l, the cupric salt is cupric pyrophosphate concentration of which is 1.8 g/l, the oxysalt is nickel nitrate concentration of which is 0.1 g/l, the complexing agent is sodium citrate concentration of which is 5 g/l, and the inhibitor is thiourea concentration of which is 0.1 g/l.

15. The electrolyte as claimed in claim 13, further comprising an inhibitor, wherein the alkali is potassium hydroxide concentration of which is 2 grams per liter (g/l), the fluoride is potassium fluoride concentration of which is 1 g/l, the silicate is sodium silicate concentration of which is 35 g/l, the cupric salt is cupric pyrophosphate concentration of which is 6 g/l, the oxysalt is nickel nitrate concentration of which is 0.1 g/l, the complexing agent is disodium ethylenediamine tetraacetate concentration of which is 3 g/l, and the inhibitor is methenamine concentration of which is 0.1 g/l.

16. The electrolyte as claimed in claim 13, further comprising an inhibitor, wherein the alkali is sodium hydroxide concentration of which is 3 grams per liter (g/l), the fluoride is potassium fluoride concentration of which is 30 g/l, the silicate is sodium silicate concentration of which is 4 g/l, the main blackening agent is cupric hydroxide concentration of which is 4.5 g/l, the oxysalt is ammonium molybdate concentration of which is 0.6 g/l, the complexing agent is ethylenediamine and sodium citrate concentrations of which are 0.5 g/l and 8 g/l respectively, and the inhibitor is thiourea concentration of which is 1.5 g/l.

17. The electrolyte as claimed in claim 13, wherein the alkali is potassium hydroxide concentration of which is 15 grams per liter (g/l), the fluoride is potassium fluoride concentration of which is 15 g/l, the silicate is sodium silicate concentration of which is 3 g/l, the cupric salt is cupric pyrophosphate concentration of which is 1 g/l, the oxysalt is ammonium metavanadate concentration of which is 8 g/l, and the complexing agent is ethylenediamine and potassium sodium tartrate concentrations of which are 2 g/l and 12 g/l respectively.

18. The electrolyte as claimed in claim 13, wherein the complexing agent comprises at least one item selected from the group consisting of acid and salt of ammonia, ethylenediamine tetracetic acid (EDTA), citric acid, tartaric acid, ethylenediamine, and trolamine.

19. The electrolyte as claimed in claim 13, further comprising an inhibitor for increase of blackening and preventing corrosion of the substrate material, wherein the inhibitor comprises at least one item selected from the group consisting of thiourea, sodium m-nitrobenzene sulfonate, and methenamine, each of the thiourea, sodium m-nitrobenzene sulfonate, and methenamine including amido, hydroxyl, or nitryl absorbing radicals.

20. An electrolyte for anodizing magnesium products, comprising:
a base solution comprising 2 to 25 g/l (grams per liter ) of alkalim, 1 to 30 g/l of fluoride, and 1 to 35 g/l of silicate;
a main blackening agent comprising 0.3 to 9 g/l of cupric salt;
an auxiliary blackening agent comprising 0.1 to 8 g/l of oxysalt;
a complexing agent concentration of which ranges from 0.5 to 20 g/l, the complexing agent comprising at least one item selected from the group consisting of acid of ammonia, ethylenediamine tetracetic acid (EDTA), citric acid, tartaric acid, ethylenediamine, and trolamine, and salt of ammonia, ethylenediamine tetracetic acid (EDTA), citric acid, tartaric acid, ethylenediamine, and trolamine; and
an inhibitor comprising at least one item selected from the group consisting of thiourea, sodium m-nitrobenzene sulfonate, and methenamine each of which comprises at least one of amido, hydroxyl and nitryl absorbing radicals, concentration of the inhibitor ranging from 0 to 5 g/l.
